(19) United States
(12) Patent Application Publication
(10) Pub. No.: US 2011/0049217 A1
(43) Pub. Date: Mar. 3, 2011

(54) WELDING APPARATUS

(76) Inventor: Viatcheslav Gnatetski, Aberdeen (GB)

(21) Appl. No.: 12/867,565

(22) PCT Filed: Feb. 6, 2009
(86) PCT No.: PCT/GB2009/050114

§ 371 Date: Oct. 25, 2010

(30) Foreign Application Priority Data
Feb. 13, 2008 (GB) 0802617.1

(51) Int. Cl. B23K 37/02

(52) U.S. Cl. 228/29

(57) ABSTRACT

A welding apparatus (24) is adapted to be mounted on a guide ring, the welding apparatus comprising a housing (25), a pair of rollers (29, 31) mounted on each side of the housing, said pair of rollers comprising a first roller (29) having a tubular outer surface and a second roller (31) having a conical outer surface, the pairs of rollers being mountable on either side of a guide ring such that an edge of the guide ring passes between each pair of rollers, the conical roller (31) on one side of the housing being laterally movable within the housing (25). The guide ring (1) comprises two arcuate components (2) connected by a flexible hinge (11), and has a removable gear rack (6). A plurality of resilient spaces (8) are mounted on the inner surface of the guide ring (1).

This invention relates to improvements in or relating to welding and more specifically to improvements in or relating to orbital welding systems and associated equipment which finds particular application in the field of pipeline welding.

Many commodities, and particularly fluids such as water, oil or gasses are transported from one location to another using a network of pipes connected together to form a pipeline which runs between locations. This may for example be between an off-shore oil or gas well and an on-shore processing facility. Pipelines may run for many hundreds or thousands of miles. The pipeline comprises individual pipes which are connected together end to end to form a continuous flowpath for the oil or gas. An individual length of pipe may be between 10 and 20 meters in length.

The standard process for connecting one end of a pipe to the end of the next adjacent pipe in the pipeline is to produce a circular weld between the two pipe ends. These welds must be very precisely made in order that the integrity of the pipeline is not compromised. In use, pipelines, particularly those carrying hydrocarbons, may be laid over the sea bed or in an underground trench where the pipeline is not easily accessible for maintenance or repair. Therefore, any loss of integrity due to the weld provided between adjacent pipes can lead to lifting of a substantial length of pipeline or digging up of a trench over a large area to find and repair the fault which is an expensive, time consuming and labour intensive operation.

It is known to use a device known as an orbital welding system to provide welds between adjacent pipe ends. The device travels along a guide ring gear rack which is mounted to a guide ring fixed around the pipe ends to which a weld is to be applied. The device is provided with a drive motor which rotates a gear wheel on the underside of the device and operates together with rollers provided on the underside of the device to drive the device around the rack.

As the device travels around the rack, a welding head mounted on the device produces a weld between the adjacent pipe ends.

Known guide rings generally comprise two rigid semi circular members which have to be mounted on the pipe through mechanical hinges at each of the free ends of the pipe. The mechanical hinges are relatively heavy and expensive in relation to the guide ring. Furthermore, the operation of mounting the guide ring can be time and labour intensive due to having to release the two mechanical hinges, reposition the guide ring and then tighten the two hinges.

Furthermore, known guide rings are provided with an integral gear rack with which the gear wheel of the welding device cooperates to drive the welding device around the guide ring. In the event that a gear rack is damaged during use, the entire guide ring has to be replaced whether or not there is any damage to the guide ring.

Known guide rings are provided with spacer elements on the inner surface of the guide rings to allow the guide ring to be mounted onto a variety of diameter of pipes. Known spacer elements are generally rigid blocks which although they provide some measure of adjustability, do not automatically provide a centralising function. If a pipe is not centralised in the guide ring, the welding head will not travel around the pipe at a uniform distance from the pipe surface and therefore the weld produced is likely to suffer from irregularities or imperfections which can lead to loss of integrity of the weld.

The rollers on the underside of known welding devices are provided at a fixed distance apart in order to allow the welding device to be mounted to a particular size of guide rack. This limitation means that additional wheel sets must be provided to carry out welding operations if different sizes of guide rings are required. Where the welding operation is being carried out off-shore, such as on a floating platform or vessel, space and weight of equipment must be considered and carrying multiple welding devices is a disadvantage.

It is an object of the present invention to provide an improved guide ring for mounting around the outer surface of a pipe in a position where a weld is required such as between the ends of adjacent pipes in a pipeline.

It is an object of the present invention to provide an improved rack over which the device travels in order to address the problem of maintaining the welding device in the optimum position as it travels around the pipe to produce a weld.

It is a further object of the present invention to provide an improved spacer to assist in mounting the rack over a pipe such that the spacer can compensate for any irregularities in the outer surface of the pipe without affecting the integrity of the weld.

It is a still further object of the present invention to provide an improved welding device which can follow the guide ring provided around the pipe to provide a more effective and accurate weld between pipes in the pipeline.

According to one aspect of the present invention there is provided a guide ring for mounting a rotary welding apparatus on the outer surface of a pipe, said guide ring comprising two arcuate components and a flexible hinge connecting the two components together.

Preferably said hinge comprises steel.

Preferably said hinge comprises spring steel

Conveniently the hinge is an elongate strip of spring steel.

Preferably also the hinge is provided with apertures to allow fixing means to connect the hinge to the guide ring components.

Advantageously, the guide ring comprises aluminium.

Preferably the outer edges of the guide ring are chamfered.

Conveniently a releasable mechanical hinge connects the free ends of the guide ring components together.

The guide ring can be mounted on a pipe by forcing apart the free ends of the two components of the ring, thereby temporarily deforming the flexible hinge. Once the guide ring is in place over the pipe, the flexible hinge returns to the rest position and the free ends of the components of the guide ring and drawn together and can be clamped in position by the mechanical clamp.

Providing a flexible hinge between the two components of the guide ring reduces the overall weight of the guide ring and provides for greater flexibility of the guide ring than is currently possible. The time taken to remove and replace the guide ring between welding operations is also significantly reduced leading to further time and cost savings.

According to a still further aspect of the present invention, there is provided a guide ring for mounting a rotary welding apparatus on the outer surface of a pipe, the guide ring comprising a removable gear rack.

Preferably a channel is provided in the surface of the guide ring within which the gear rack may be mounted.

Conveniently aligned apertures are provided in the guide ring and the gear rack through to receive fixing means for releasably connecting the gear rack to the guide ring.

Preferably the apertures in the guide ring are provided in the channel.

Advantageously, the gear rack comprises steel.

Preferably, the guide ring comprises aluminium.

By providing a removable and replaceable gear rack on the guide ring, should the gear rack become damaged it can be quickly and easily removed without having to replace the entire guide ring. This leads to significant materials saving in replacing guide rings unnecessarily.

By providing an aluminium guide ring with a steel gear rack, the cost and wear of the guide ring and gear rack are also reduced.

According to a further aspect of the present invention there is provided a spacer adapted to be mounted to the inner surface of a guide ring for supporting a welding apparatus on the outer surface of a pipe, the spacer comprising a first planar member, a second planar member and a third planar member, the first and second planar members being joined together at one end and the second and third planar members being joined together at the other end, the second planar member being provided between the first and third planar members.

Advantageously the spacer comprises steel and/or aluminium or a combination.

Preferably, the first, second and third planar members are integrally formed.

Conveniently the first, second and third planar members are substantially rectangular in form.

Preferably also, the first planar member is provided with one or more projecting legs, said legs projecting from the upper surface of the first planar member.

Conveniently a bore is provided in each leg. Preferably the bore is an axial bore and most preferably the bore is threaded to receive a screw thread fixing.

Advantageously the third planar member is provided with one or more projecting feet, said feet projecting from the lower surface of the third planar member.

When the spacer is mounted between the inner surface of a guide ring and the outer surface of a pipe, the spacer automatically adjusts the distance between the first and second members at one end of the spacer and the distance between the second and third members at the other end of the spacer to fill the space available.

When a plurality of spacers are mounted around the inner surface of a guide ring, the spacers provide a self levelling operation and also provide for automatic centralising of the pipe within the guide ring. Any irregularities in the outer diameter of the pipe are compensated for by one or other of the spacers adjusting to take up the additional space.

Furthermore, as the spacers provide a centralising function, the welding head of a welding device remains at a constant distance from the surface of the pipe as the welding device travels around the pipe. This provides a significant improvement in the integrity of the weld over known welding apparatus.

According to a fourth aspect of the present invention there is provided a welding apparatus adapted to be mounted on a guide ring, said welding apparatus comprising a housing, two pairs of rollers mounted on each side of the housing, each pair of rollers comprising a first roller having a tubular outer surface and a second roller having a conical outer surface, the pairs of rollers being mounted on either side of a guide ring such that an edge of the guide ring passes between each pair of rollers, the conical rollers on one side of the housing being laterally movable within the housing.

Preferably the movable rollers are spring loaded.

Preferably also the movable rollers are biased to a position inwardly of the tubular rollers on that side of the housing.

Advantageously the conical rollers are mounted on a spindle projecting from the housing and the spring bias is provided by a compression spring mounted on the spindle between the housing and the conical rollers.

Preferably also, the conical rollers on each side of the housing are angularly offset from the tubular rollers.

By spring loading the conical rollers on one side of the housing to a position inwardly of the tubular rollers, the conical rollers can automatically adjust to accommodate different sizes of guide ring without having to change the welding apparatus. This reduces the pieces of welding equipment necessary to carry out a range of welding operations. In an off-shore environment this leads to a saving in weight and cost.

Furthermore as a welding device can be used with a range of guide ring sizes, a damaged guide ring can be replaced by a guide ring of a different size without having to shut down a welding operation until the correctly sized guide ring is sourced.

Embodiments of the present invention will now be described with reference to and as shown in the accompanying drawings in which:—

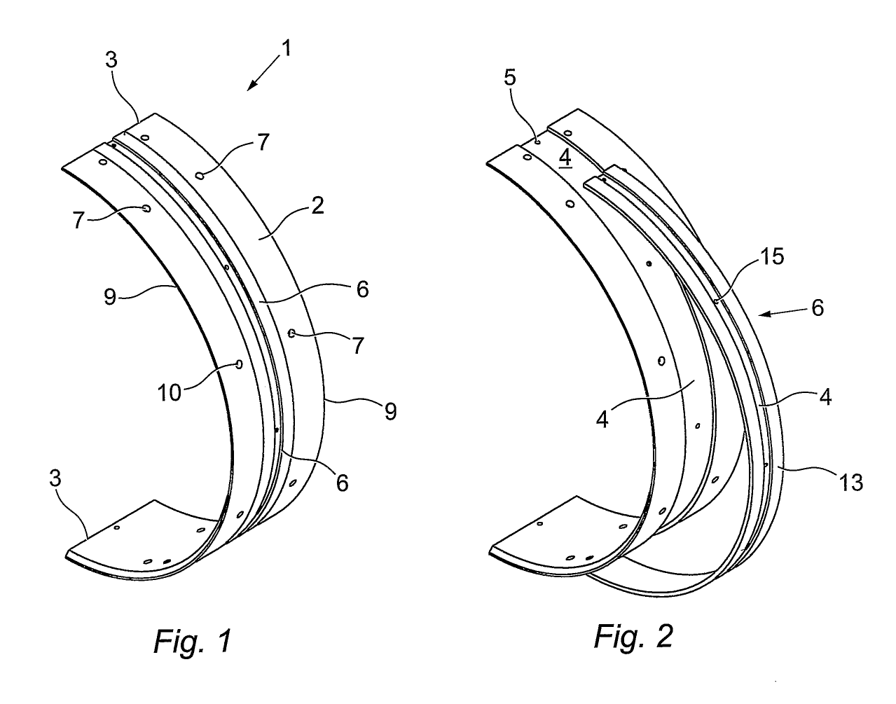

FIG. 1 is a schematic perspective view of one component of a guide ring according to one aspect of the present invention with a gear rack mounted thereon;

FIG. 2 is a schematic perspective exploded view of the guide ring and gear rack of FIG. 1;

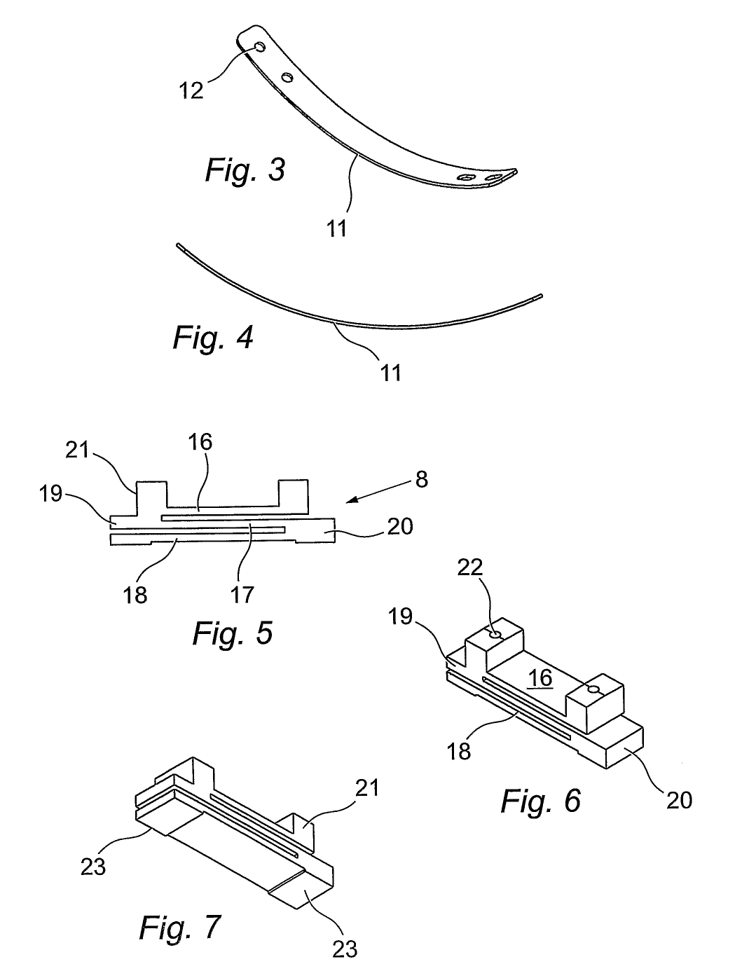

FIG. 3 is a schematic perspective view of a spring hinge according to a further aspect of the present invention;

FIG. 4 is a side view of the spring hinge of FIG. 3;

FIG. 5 is a schematic side view of a flexible spacer according to a further aspect of the present invention;

FIG. 6 is a schematic perspective view of the spacer of FIG. 5 from above;

FIG. 7 is a schematic perspective view of the spacer of FIG. 5 from below;

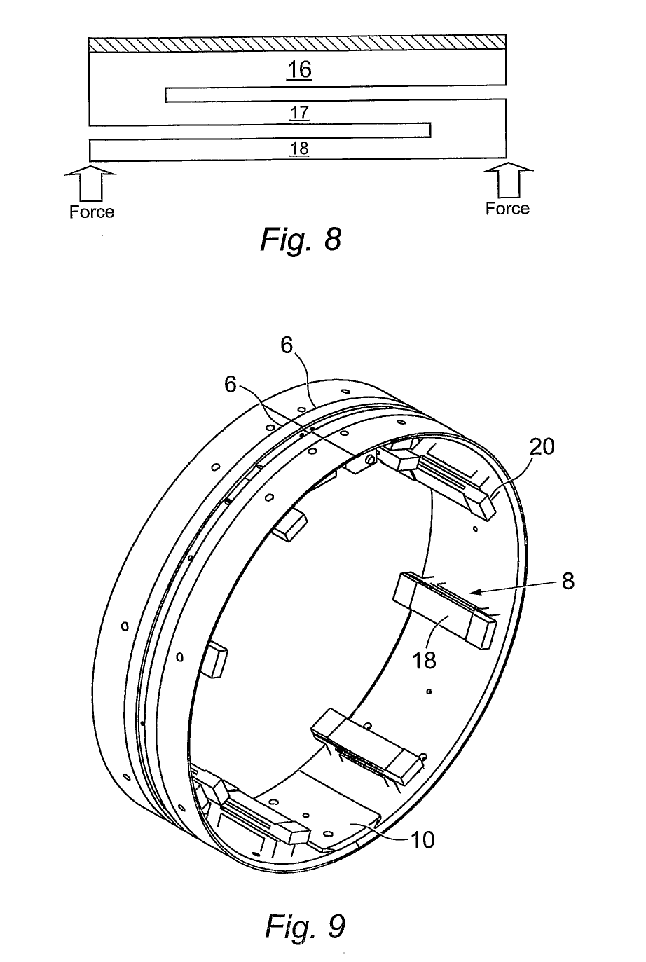

FIG. 8 is a force diagram showing the forces acting on the spacer of FIG. 5;

FIG. 9 is a schematic perspective view of the guide ring of FIG. 1 with flexible spacers of FIG. 5 mounted thereon;

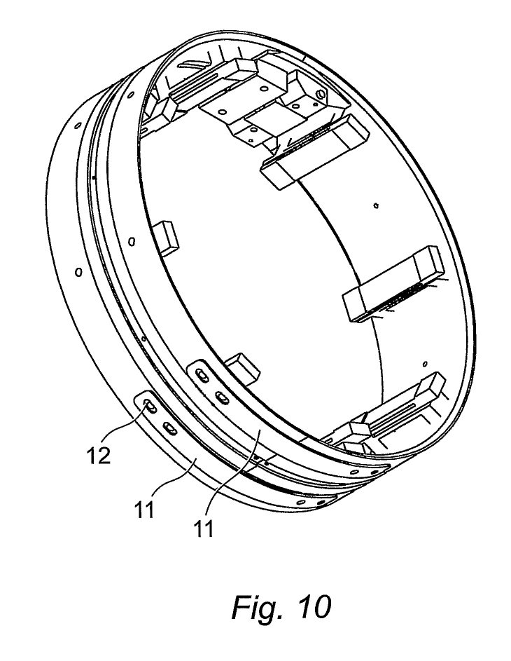

FIG. 10 is a schematic perspective view of the guide ring of FIG. 1 with the spring hinge of FIG. 3 mounted thereon;

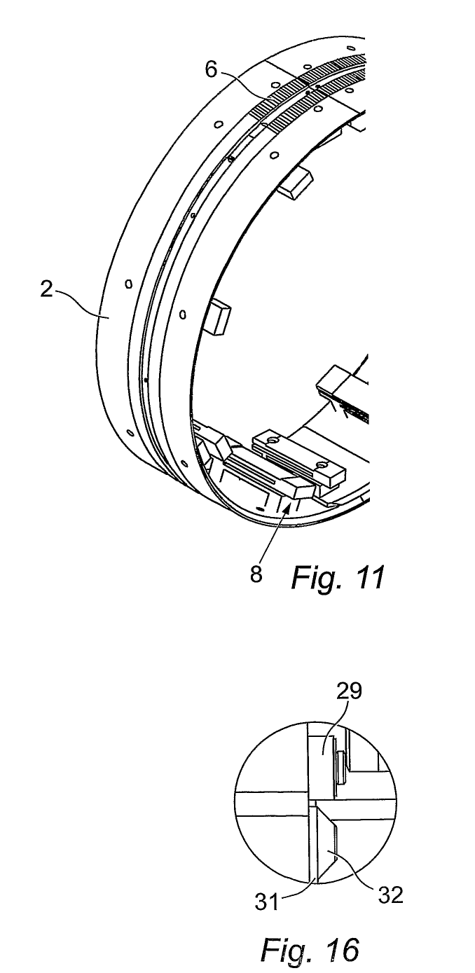

FIG. 11 is a schematic perspective view of the guide ring of FIG. 1 showing the gear teeth on the gear rack;

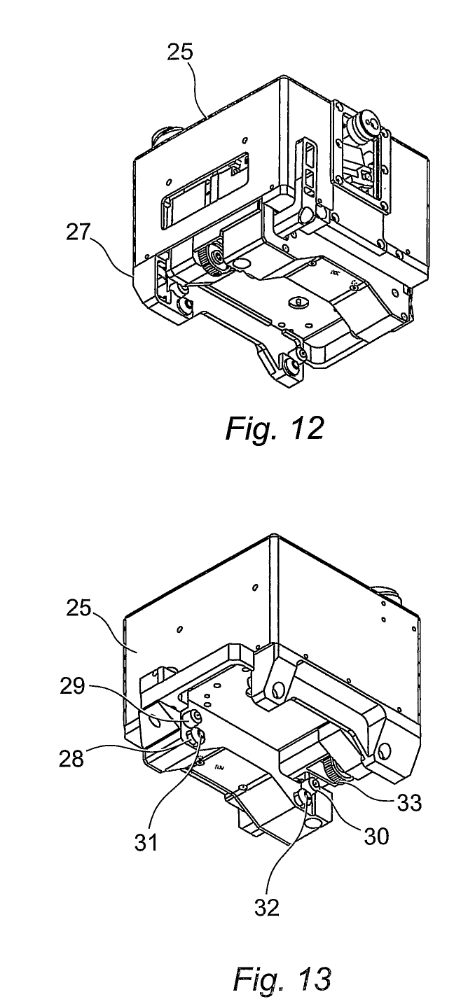

FIG. 12 is a schematic perspective view from below and one side of a welding device according to a further aspect of the present invention;

FIG. 13 is a schematic perspective view from below and the other side of the welding device of FIG. 12;

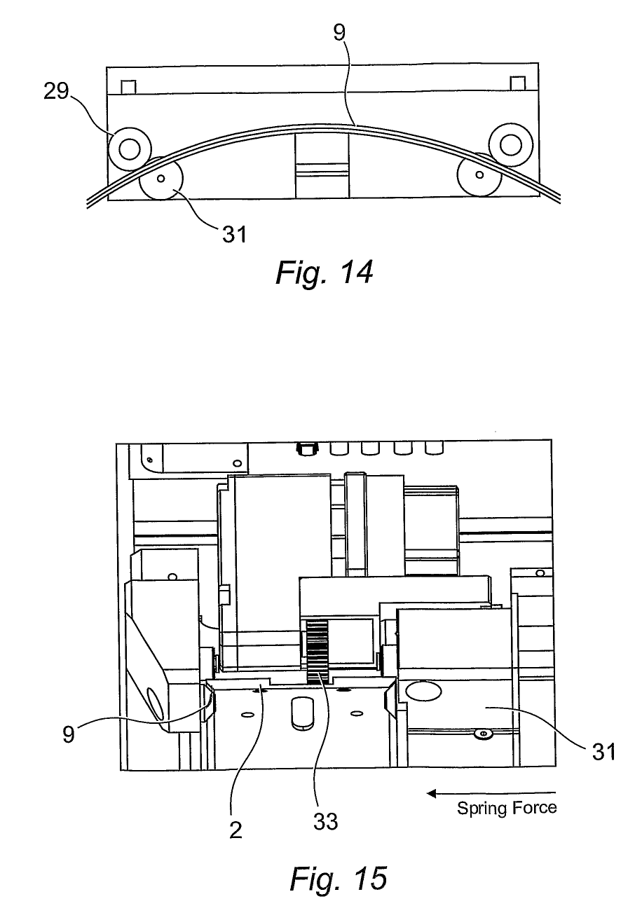

FIG. 14 is a schematic side view of the rollers of the welding device of FIG. 12 mounted upon the guide ring of FIG. 1;

FIG. 15 is a schematic end view of the rollers mounted on the guide ring;

FIG. 16 is a detailed view of the rollers in contact with the guide ring, and

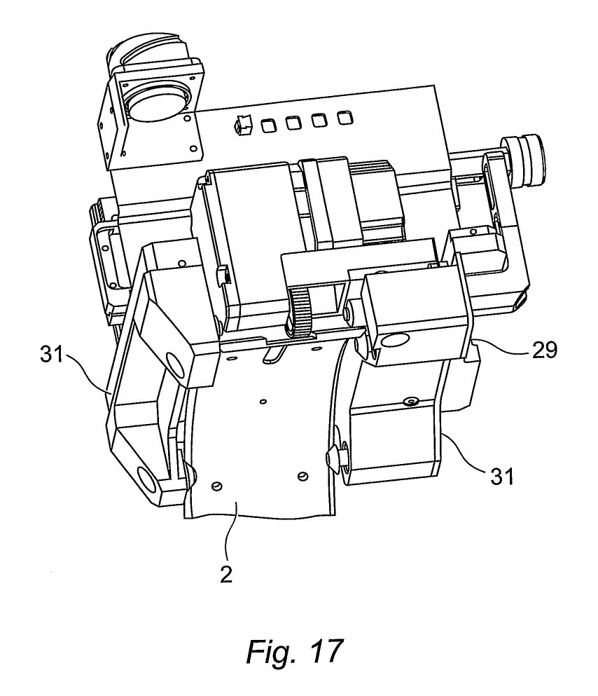

FIG. 17 is a schematic perspective view from below of the welding device of FIG. 12 mounted to the guide ring of FIG. 1.

Turning now to the figures, there is shown in FIG. 1 a guide ring 1 adapted to be mounted around the outer surface of a pipe about which a weld is to be provided. The guide ring 1 is preferably formed of a metal and most preferably comprises aluminium. This makes the guide ring lighter than prior art guide rings but also improves the resistance to weld spatter during the welding process and corrosion during use.

Weld spatter is the spray of molten metal which gets ejected from the weld. Any molten pieces which land on ferrous metals will result in cohesion to the parent material. Since aluminium does not contain any carbon the spatter may adhere to the surface but would not create an intermetallic bond.

Additionally, aluminium performs well when exposed to moisture and a high humidity environment and is also significantly cheaper in comparison to a high quality, rust resistant stainless steel without sacrificing any of the functionality of that material.

The outer surfaces of the guide ring may be treated with a hard anodising coating such as KERONITE™. This coating turns the outer surface of the aluminium guide ring into a ceramic based material (alumina) which is very hard and stable thereby further improving the strength and surface durability of the guide ring.

Tests have been conducted on an aluminium guide ring in which half of the outer surface of the ring is coated with a KERONITE™ coating. The tests included strength, lightness, wear resistance and spatter resistance and the results indicate that no physical damage occurs to the coating although the surface may blemish and no spatter adheres to the surface therefore giving the same advantages as with aluminium alone.

In the embodiments shown, the guide ring 1 is formed by arcuate guide ring components 2 each formed of material as described above. The free ends 3 of the components are connected together to form the components into an annular body which can be mounted around the outer surface of a pipe.

An annular channel 4 is provided substantially around the centre of the outer surface of the guide ring and the function of the channel will be described further below. The annular channel is preferably machined into the outer surface of the guide ring.

Apertures 5 are provided in the annular channel 4 to allow fixing means to mount a gear rack 6 within the channel as will be described further below. The apertures are substantially equidistantly spaced apart.

Pairs of apertures 7 are also spaced around the guide ring on either side of the annular channel 4. These apertures pass through the guide ring and are provided to mount spacer components 8 to the inner surface of the guide ring as will be described further below.

The guide ring 1 is profiled at the edges 9 having a slight chamfer on the inside radius as will be described further below.

The free ends 3 at one side of the guide ring are connected together via a mechanical hinge 10 to enable the guide ring to be opened and closed around the outer surface of a pipe. The mechanical hinge is internally mounted within the guide ring so that it does not inhibit the travel of a welding apparatus around the guide ring.

The free ends 3 of the guide ring at the other side are connected together through a spring hinge 11 which is shown in more detail in FIG. 3. The spring hinge comprises an arcuate strip of steel and preferably spring steel which is releasably mounted over the free ends of the two components of the guide ring.

Apertures 12 are provided adjacent the ends of the spring hinge through which fixing means such as in the form of bolts or studs can be passed to fix the spring hinge in position across the joint of the components of the guide ring. In the embodiment shown, two spring hinges 11 are mounted between the guide ring components, one on either side of the channel 4 in the outer surface of the guide ring.

The spring hinges 11 are resilient such that they can flex without permanently deforming which enables the guide ring 1 to be opened at one side only through the mechanical hinge 10 when the guide ring is placed over or around a pipe to which a weld is to be applied. This leads to a reduction in costs, is space saving and also reduces wear on the components.

A gear rack 6 is mounted within the channel 4 provided around the outer surface of the guide ring 1. The gear rack provides a motion interface between a welding device and the guide ring.

The gear rack 6 comprises two rack components 13 which are formed as a strip of material substantially semi-circular in form. The two components are preferably formed of carbon steel which is relatively cheap, widely available and easily machined.

The two components are removably mounted within the channel 4 in the surface of the guide ring 1 to provide for motion transfer around the entire outer surface of the guide ring. By providing a removable rack this allows for ease of service and maintenance. Furthermore, in the case of damage to the gear rack, the rack, or either component of the rack can be replaced without replacing the entire guide ring.

Each rack component 13 has a machined groove 14 provided in the outer surface thereof as will be explained further below.

Apertures 15 are provided through the rack components, within the groove 14, which can be aligned with the apertures 5 in the channel of the guide ring. Fixing means (not shown) pass through the aligned apertures of the rack and the guide ring to secure the rack components to the guide ring.

Gear teeth (not shown) are provided on the rack. The gear teeth may be provided on the bottom of the groove and/or on the side edges of the groove and/or on the upper surface of the rack. The spacing of the gear teeth can be selected depending upon the required operating characteristics of the welding process to be carried out.

A plurality of resilient spacers 8 are mounted on the inner surface of the guide ring. The spacers aid in centring the guide ring 1 around the outer surface of a pipe and also accommodate any inconsistencies or irregularities in the outer diameter of the pipe.

The resilient spacers are preferably formed of aluminium which is light and easily machined but resists corrosion which is important in the context of their use in a welding environment.

Each spacer comprises a lower 16, middle 17 and upper beam 18, each beam being substantially rectangular in form. The lower and middle beams 16,17 are connected together at one end 19 and the middle and upper beams 17,18 are connected together at the other, remote end 20. Preferably the lower and middle beams and the middle and upper beams are integrally connected together at the respective ends.

The terms “lower” and “upper” are used in order of the distance of the beams from the inner surface of the guide ring.

The lower beam 16 is adapted to be mounted to the inner surface of the guide ring and in the embodiment shown comprises two legs 21 which project at substantially 90 degrees from the top surface of the lower beam. Each leg is provided substantially at one end of the beam respectively.

The legs 21 of the lower beam are provided at the ends of the lower beams but inwards of the ends of the middle and upper beams.

Bores 22 are provided in the ends of the legs, the diameter of the bores being sized to correspond to the paired apertures in the surface of the guide ring. Therefore, each spacer 8 can be mounted to the inner surface of the guide ring by passing fixing means through the paired apertures 7 in the guide ring into the bores 22 in the legs of the spacer.

In some embodiments the inner surface of the bores may be threaded to receive a screw fixing which will be tightened to draw the spacer into close contact with the inner surface of the guide ring.

A foot 23 is formed at either end of the surface of the upper beam 18 which is innermost of the guide ring 1 when the spacer is mounted to the ring. For ease of reference this surface will be referred to as the upper surface of the spacer.

The feet 23 project a short distance from the upper surface of the upper beam 18 and provide substantial pressure and force to achieve grip on the surface of the pipe when the guide ring is placed upon the pipe. In the embodiment shown, the feet are provided at the outer extremity of the ends of the upper beam and extend along the beam to a point which is beneath the connections between the upper and middle beams and the middle and lower beams.

The flexible spacers 8 extend from the inner surface of the guide ring in use by a slightly greater amount than the mechanical hinge.

Whilst the flexible spacers are relatively simple in form, they serve a very important function. Each spacer acts as a spring, the longitudinal cut-outs between the lower and middle beam and between the middle and upper beams allows the spacer to deform, however the geometry of these cut-outs and the material properties is very important. It is also important that the flexible beams will flex elastically at the same time delivering substantial force to keep the guide ring in place.

FIG. 8 shows a schematic view of a flexible spacer 8 in which the legs and feet are removed for illustrative purposes and the beams are all made the same length. Force is applied to the ends of the lower beam 16.

The geometrical dimensions can be derived from basic beam mechanics equations.

The calculations are carried out on the middle beam only since the lower beam would not deflect; it is there for contacting/locating purposes only. The boundary conditions for this arrangement are such that the left end of the beam is assumed to be fixed and the right end is assumed to be guided.

The results state the limiting deflection to be 0.87 mm from which 112.75N of force will be produced. Using 8 of these spacers gives a significant radial pressure to maintain the guide ring in place and also take into account any pipe radial tolerance errors.

FIGS. 12 and 13 show an orbital welding apparatus 24 or device which is adapted to be mounted on the guide ring 1 described above to move around the surface of a pipe producing a circumferential weld.

The welding device 24 comprises a housing 25 within which the control components for the device are mounted. A welding head 26 is mounted on one side of the housing.

The housing 25 is provided on a chassis 27 which extends below the under surface of the housing and enables the housing to travel around the guide ring.

Rollers are mounted within the chassis 27 to mount the device onto the guide ring. The rollers are spaced apart on each side of the chassis below the housing by a suitable distance to allow the rollers to contact each side of the guide ring 1 when the device is mounted on the ring. Each roller is mounted on a spindle 28 which extends substantially perpendicularly from the chassis. The spindles on each side of the chassis extend towards the spindles on the other side of the chassis.

Each side of the chassis is provided with two pairs of rollers. Each pair of rollers comprises a first roller 29 having a constant diameter across its length. Such a roller will now be described as a tubular roller. The tubular roller has a substantially smooth outer surface 30. The second roller 31 has a substantially conical outer surface 32 which reduces in diameter from the chassis to the end of the roller.

The conical rollers 32 are angularly offset from the tubular rollers 29 and are mounted slightly below and inwardly of the tubular rollers. The conical rollers 32 on one side of the chassis are spring mounted on the spindles 28 such that the conical rollers on that side can move inwardly and outwardly of the fixed tubular rollers as will be described further below.

A toothed gear wheel 33 is mounted on the underside of the housing 25 of the device at a position substantially equidistant from the rollers on each side of the chassis 27. The teeth on the gearwheel are spaced to correspond to the spacing of the teeth on the gear rack6 mounted to the guide ring 1. The toothed gear wheel is driven by a motor within the housing of the device in a standard manner.

The use of the apparatus will now be described.

When a circumferential weld is required for example around the outer surface of a pipe such as to join two pipe ends together in a pipeline, the gear rack 6 is mounted into the channel 4 in the outer surface of the guide ring 1 by passing fixing means through the aligned apertures 15, 5 in the groove of the gear rack and the channel of the guide ring.

A plurality of flexible spacers 8 are then mounted to the inner surface of the two guide ring components. Fixing means such as a screw fixing are passed through the paired apertures 7 in the guide ring and extend into the bores 22 in the legs of the spacers to draw the spacers into close contact with the inner surface of the guide ring. Eight spacers are shown in the illustrated embodiment but any number of spacers may be used depending upon the operating conditions and the user requirements.

The guide ring 1 is then fixed around the outer surface of the pipe in the required position. The spring hinge 11 of the guide ring allows the guide ring to be opened and placed upon the pipe. The spring hinge deforms sufficiently to open and close the guide ring but returns to its rest state once the guide ring is positioned around the pipe. The mechanical hinge 10 at the other end of the guide ring components can then be connected to fix the guide ring securely around the surface of the pipe.

A welding device 24 is then mounted to the guide ring 1. The guide ring is profiled at the edges 9 having a slight chamfer on the inside radius which matches the angle of the conical rollers 31 provided on the chassis of the device. The guide ring 1 is passed between the tubular and conical rollers 29, 31 on each side of the chassis of the device such that the tubular rollers contact the upper surface of the guide ring and the conical rollers contact the inner surface of the guide ring.

The toothed wheel 33 on the underside of the housing 25 of the device contacts the teeth on the gear rack 6 of the guide ring. The toothed wheel of the device is driven by a motor within the housing of the device. As the toothed wheel co-operates with the teeth on the gear rack, the device is driven around the outer surface of the pipe.

As described above, the conical rollers 31 on one side of the chassis are fixed whilst the conical rollers 31 on the other side of the chassis are movable. The moveable rollers are spring biased by a spring which applies a force in the inward direction.

The force from the spring pushes the conical rollers 31 on one side of the chassis inwardly toward the guide ring side face 9 and as the rollers 31 move inwardly of the chassis, the outer diameter of the conical roller which is in contact with the side surface of the guide ring increases. This increase in diameter wedges the conical surface 32 of the rollers under the chamfered edge 9 of the guide ring. This firmly pushes the guide ring up against the upper tubular rollers 29 and prevents any sideways motion of the guide ring.

Any change in diameter of the guide ring 1 will affect the sprung conical roller, however these changes will be counteracted by the spring and the position of the conical roller automatically adjusts for the changes.

The arrangement of rollers as described above enables the welding device 24 to be used with any size of guide ring 1, through to a flat plate with minimal adjustment of the rollers.

The combination of the guide ring side profile 9 together with the arrangement and shape of the rollers 29, 31 allows for greater flexibility in the welding operation.

1. An orbital welding apparatus adapted to be mounted on a guide ring, said welding apparatus comprising:
a housing;
a pair of rollers mounted on each side of the housing, each pair of rollers comprising:
a first roller having a tubular outer surface; and
a second roller having a conical outer surface;
wherein the pairs of rollers are mounted on either side of a guide ring such that an edge of the guide ring passes between each pair of rollers, the conical rollers on one side of the housing being laterally movable within the housing.

2. An orbital welding apparatus according to claim 1, wherein two pairs of roller are mounted on each side of the housing.

3. An orbital welding apparatus according to claim 1, wherein the movable roller(s) is/are spring loaded.

4. An orbital welding apparatus according to claim 1, wherein the movable roller(s) is/are biased to a position inwardly of the tubular rollers on that side of the housing.

5. An orbital welding apparatus according to claim 4, wherein the conical roller(s) is/are mounted on a spindle projecting from the housing.

6. An orbital welding apparatus according to claim 5, wherein the spring bias is provided by a spring mounted on the spindle between the housing and the conical rollers.

7. An orbital welding apparatus according to claim 6, wherein the spring is a compression spring.

8. An orbital welding apparatus according to claim 1, wherein the conical rollers on each side of the housing are angularly offset from the tubular rollers.

9. (canceled)

10. A guide ring for mounting a rotary welding apparatus on the outer surface of a pipe, said guide ring comprising:
two arcuate components; and
a flexible hinge connecting the two components together.

11. A guide ring according to claim 10, wherein said hinge comprises steel.

12. A guide ring according to claim 11, wherein said hinge comprises spring steel.

13. A guide ring according to claim 11, wherein said hinge comprises an elongate strip of spring steel.

14. A guide ring according to claim 10, wherein the hinge is provided with apertures to allow fixing means to connect the hinge to the guide ring.

15. A guide ring according to claim 10, wherein the guide ring comprises aluminum.

16. A guide ring according to claim 10, wherein the outer edges of the guide ring are chamfered.

17. A guide ring according to claim 10, wherein a releasable mechanical hinge connects the free ends of the guide ring components together.

18. (canceled)

19. A guide ring for mounting a rotary welding apparatus on the outer surface of a pipe, the guide ring comprising a removable gear rack.

20. A guide ring according to claim 19, wherein a channel is provided in the surface of the guide ring within which the gear rack may be mounted.

21. A guide ring according to claim 19, wherein aligned apertures are provided in the guide ring and the gear rack to receive fixing means for releasably connecting the gear rack to the guide ring.

22. A guide ring according to claim 21, wherein the apertures in the guide ring are provided in the channel.

23. A guide ring according to claim 19, wherein the gear rack comprises steel.

24. A guide ring according to claim 19, wherein the guide ring comprises aluminum.

25. (canceled)

26. A spacer adapted to be mounted to the inner surface of a guide ring for supporting a welding apparatus on the outer surface of a pipe, the spacer comprising:
a first planar member;
a second planar member and a third planar member;
wherein the first and second planar members are joined together at one end and the second and third planar members being joined together at the other end; and
wherein the second planar member is provided between the first and third planar members.

27. A spacer according to claim 26, wherein the spacer comprises steel and/or aluminum or a combination of both.

28. A spacer according to claim 26, wherein the first, second and third planar members are integrally formed.

29. A spacer according to claim 26, wherein the first, second and third planar members are substantially rectangular in form.

30. A spacer according to claim 26, wherein the first planar member is provided with one or more projecting legs.

31. A spacer according to claims 30, wherein said legs project from the upper surface of the first planar member.

32. A spacer according to claim 30, wherein a bore is provided in each leg.

33. A spacer according to claim 32, wherein the bore is an axial bore.

34. A spacer according to claim 33, wherein the bore is threaded to receive a screw thread fixing.

35. A spacer according to claim 26, wherein the third planar member is provided with one or more projecting feet.

36. A spacer according to claim 35, wherein said feet project from the lower surface of the third planar member.

37. (canceled)
